(19) United States
(12) Patent Application Publication
(10) Pub. No.: US 2026/0320839 A1
(43) Pub. Date: Oct. 15, 2026

(54) SYSTEM AND A METHOD TO ACHIEVE SINGLE-SHOT STEREO CALIBRATION

(71) Applicant: IRIDA LABS S.A., Patras (GR)

(72) Inventors: Nikos FRAGOULIS, Patras (GR); Vasileios POTHOS, Patras (GR)

(21) Appl. No.: 19/704,923

(22) Filed: Jun. 11, 2026

Related U.S. Application Data
(62) Division of application No. 19/172,287, filed on Apr. 7, 2025.

(51) Int. Cl. G06T 7/80; H04N 13/15; H04N 13/246; H04N 13/254; H04N 13/388

(52) U.S. Cl. CPC G06T 7/85; H04N 13/15; H04N 13/246; H04N 13/254; H04N 13/388; G06T 2207/10012; G06T 2207/30204; G06T 2207/30244

(57) ABSTRACT

One exemplary aspect relates generally to camera calibration and, more particularly, to methods and systems for performing single-shot single or stereo camera calibration of wide-angle or fisheye camera pairs using a specially arranged calibration target. One exemplary advantage is that the system provides a technique for calibrating fisheye or wide-angle camera(s) without requiring multiple viewpoints.

### BACKGROUND

### Field

One exemplary aspect relates generally to camera calibration and, more particularly, to methods and systems for performing single-shot single or stereo camera calibration of wide-angle or fisheye camera pairs using a specially arranged calibration target.

### Description of Related Art

Camera calibration is a fundamental process in computer vision that is essential for enabling precise three-dimensional reconstruction, accurate distance measurement, and effective image rectification. In order to achieve these outcomes, the calibration process typically involves determining the intrinsic parameters of a camera—such as the focal length, principal point, and various distortion coefficients—and the extrinsic parameters, which describe the camera's position and orientation (its pose) in a given coordinate system.

Traditional calibration methods require capturing multiple images of a well-known calibration target, such as a checkerboard pattern, from a range of different angles and distances. This multi-image approach is necessary to ensure that enough data is collected so that the calibration technique can robustly estimate the camera parameters. In the case of a stereo setup, where two or more cameras are used, additional constraints must be imposed to determine the relative transformation between the cameras, typically expressed in terms of a rotation matrix R and a translation vector t.

Despite its widespread use, the conventional multi-image calibration process has several notable drawbacks. First, the process is inherently time-consuming because it requires repositioning the camera or the calibration target for each capture. This not only increases the overall calibration time but also introduces potential delays in high-throughput environments. Second, the workflow associated with multi-shot calibration is often complex and labor-intensive. In industrial settings, where large production volumes and rapid turnaround times are critical, such complex and time-consuming procedures are often impractical and inefficient.

In contrast, some approaches have attempted to address these issues by employing single-shot calibration boards. These specialized targets are designed with multi-pattern or multi-plane features in order to gather sufficient three-dimensional constraints from just one image capture. However, many existing single-board solutions fall short in practical applications. In particular, they frequently do not provide adequate coverage of the field of view associated with fisheye or ultra-wide-angle lenses, and they often lack the robust three-dimensional structural cues necessary for reliable stereo extrinsic estimation. As a result, while single-shot boards offer the promise of a faster calibration process, their limitations can lead to reduced accuracy in scenarios that demand high-precision calibration.

Consequently, there remains a pressing and unmet need for a unified system and technique that can perform both single-camera calibration (especially in scenarios where fisheye or wide-angle distortion is significant) and stereo calibration (which involves determining the extrinsics between two or more cameras) using only a single image capture of a suitably arranged target or scene. Such a unified approach would dramatically simplify the calibration process by eliminating the need for multiple captures and complex repositioning procedures, while still providing accurate estimates of the intrinsic parameters, such as the camera matrix K and distortion coefficients D, as well as the extrinsic parameters, including the rotation matrix R and translation vector t. This advancement would be particularly beneficial in, just as one example, industrial environments, where rapid, reliable, and efficient calibration is critical to maintaining high productivity and ensuring the quality of subsequent computer vision tasks.

### SUMMARY

One exemplary aspect provides a comprehensive system and method for calibrating cameras from a single captured image, a technique especially beneficial for wide-angle or fisheye lenses. The method applies to both monocular and multi-camera configurations. At its core is an advanced algorithmic framework that processes feature detections from a single view (or simultaneous stereo views), using a predetermined 3D reference to estimate intrinsic parameters—such as focal length, principal point, and lens distortion—and, where needed, extrinsic parameters that define camera pose or stereo baselines.

One exemplary aspect lies in its single-view paradigm, which eliminates the need to capture multiple images from varying viewpoints. By streamlining the workflow to a single shot, the system can achieve faster, more reliable calibration—an advantage particularly valuable in industrial and high-volume production settings where downtime must be minimized. The technique leverages a robust optimization pipeline that processes known three-dimensional references. These references may originate from multi-plane targets, volumetric distributions of markers, or other innovative setups.

Unlike traditional calibration solutions reliant on a single, flat checkerboard, one embodiment incorporates flexible target designs that simplify fisheye calibration and ensure comprehensive coverage of each camera's field of view. Furthermore, four particularly novel exemplary embodiments are disclosed:
1. A Multi-Board Reconfigurable Arrangement in which multiple planar surfaces—each controllable by motorized actuators in up to three degrees of freedom—are oriented to span and fully illuminate the camera's field of view.
2. An Actuator-Based 3D Target utilizing telescopic or motorized rods to reposition markers within a three-dimensional volume, thus dynamically adapting to different fields of view or lens types.
3. A Hanging Marker Setup wherein markers are suspended at various heights from thin, transparent threads, potentially with rolling mechanisms to adjust hanging height electronically, reducing interference within the field of view.
4. A 3D Volumetric Display System that forms “floating” markers in space via advanced optical projection methods, such as ionizing lasers (used with suitable fog materials) or rotating LED bars, creating ephemeral but precisely positioned markers.

These four target designs allow the technology to be tailored to each camera's distortion characteristics, ensuring single-shot calibration remains robust, efficient, and accurate across a wide range of lens types—including fisheye optics with strong radial distortion. As a result, practitioners in industrial, research, and specialized fields can at least benefit from minimal calibration time, comprehensive field-of-view coverage, and fully single-shot workflows for even the most demanding vision applications.

### BRIEF DESCRIPTION OF THE DRAWINGS

The exemplary embodiments will be described in detail, with reference to the following figures, wherein:

FIG. 1 is a high-Level System Diagram showing the exemplary components of the calibration system, including a camera (or stereo rig), a calibration target or known 3D environment, and a computing device running the calibration algorithm.

FIGS. 2A-D are example Target Configurations (2A) a volumetric reconfigurable actuator-based target, (2B) a volumetric reconfigurable roll-on actuator-based target a volumetric set of markers, (2C) a multi-board arrangement with angled planes and (2D) a volumetric holographic projection setup.

FIGS. 3A-C are dynamic control elements of (3A) a volumetric set of markers (3B) a volumetric hanging-marker setup (3C) a multi-level board setup.

FIG. 4 is a Flowchart detailing the exemplary single-image calibration pipeline (preprocessing, feature detection, matching, optimization, validation).

FIGS. 5A-B are an Example Calibration Results featuring before (5A) and after (5B) undistortion.

FIGS. 6A-C is an embodiment of a multi-level board calibration setup. (6A) an example of a multi-board element implementation (6B) Top-view of a multi-board setup (6C) a 3D (angled) view of a multi-board setup and a table with the positions and angles.

FIGS. 7A-B show an effect of a discontinuity (7A) on the distortion function and (7B) on the rectified image.

FIG. 8 shows exemplary hollographic Tags (CiraTags).

### DETAILED DESCRIPTION

### 1. Exemplary System Overview

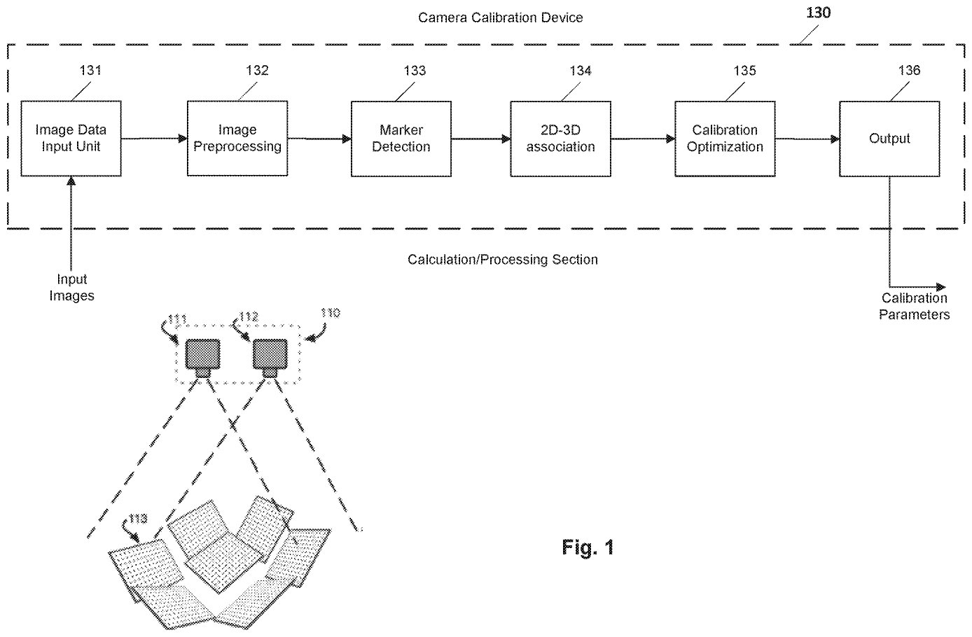

Referring to FIG. 1, the calibration system comprises multiple components that work together to enable single-shot calibration of both single-camera and stereo imaging systems. The system includes a camera subsystem 110, a calibration target or reference scene 113, and a computing device 130 responsible for executing the calibration technique.

The camera subsystem 110 may include a single camera, in the case of monocular calibration, or a stereo rig including a left camera 111 and a right camera 112 for calibrating extrinsic parameters between two imaging devices. These cameras can vary in their field of view, with a particular focus on fisheye lenses or ultra-wide lenses, which introduce significant radial and tangential distortion.

The calibration target or reference scene 120 provides a set of known 3D references, which the technique will use to estimate intrinsic and extrinsic parameters from a single image capture. This reference structure may be implemented in different forms, including but not limited to:
1. A multi-board reconfigurable arrangement, where multiple planar surfaces controlled by motorized actuators in 3DoFs are arranged at different orientations to ensure that the field of view is fully covered.
2. An actuator-based reconfigurable 3D target that uses telescopic or motorized rods to move markers within a volume,
3. A 3D hanging marker setup where the camera setup is at the bottom and the markers are hanging in various heights from thin transparent threads for reducing interference in the FoV. Threads can also feature a rolling mechanism to control the hanging height electronically.
4. A 3D volumetric display system that creates floating volumetric markers within a 3D volume, using advanced optical projection means (ionizing lasers with special fogs, or rotating LED bars etc.)

The computing device 130 is responsible for processing the captured images and executing the single-shot calibration technique. This device may be a workstation, an embedded processor(s), a GPU(s), and/or a cloud-based system, depending on the deployment scenario. It is responsible for feature detection, matching, and nonlinear optimization to derive accurate calibration parameters.

One exemplary aspect lies in the exemplary approach that extracts intrinsic and extrinsic parameters from a single image capture. As depicted in FIG. 1, an image acquisition module 131 gathers raw image data from the camera system 110, which may include a single camera or multiple cameras capturing simultaneous frames. The acquired images are then channeled to a preprocessing stage 132, where noise filtering, contrast enhancement, and other conditioning methods are applied. This step can optionally maximize clarity and contrast, ensuring that the calibration target 113—whether implemented as a multi-board arrangement, a volumetric rig, or holographic markers—stands out for reliable detection.

Once pre-processed, the images are handed off to a fiducial marker detection module 133, which identifies and localizes each marker, dot, or coded pattern that resides on the target 113. The resulting two-dimensional detections are subsequently routed to a 2D-3D association unit 134, where the system cross-references each detected marker's pixel coordinates with its known three-dimensional location. By establishing this 2D-3D correspondence, the method then proceeds to solve for intrinsic camera parameters and any necessary extrinsic transformations using a single snapshot of the target by engaging a calibration optimization process 135 and output the results 136.

### 2. Example Target Configurations

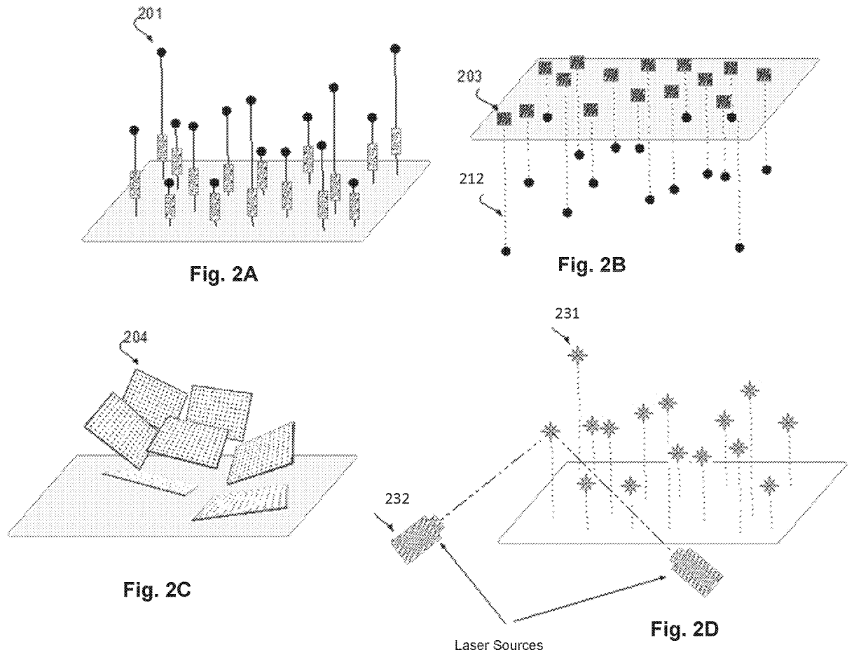

This section describes the various calibration target configurations developed to enable single-shot calibration for both single-camera and stereo/multicamera systems. The embodiments illustrated in FIGS. 2A-2D are designed to provide a robust three-dimensional structure from a single image capture, a necessity when dealing with wide-angle or fisheye lenses. By combining an overview of the target styles with in-depth practical details and advantages, this section outlines how each configuration addresses traditional calibration challenges—such as time consumption, misalignment, and the complexity of multi-shot processes—while ensuring high accuracy and efficiency.

### 2.1 Telescopic/Actuator-Based Reconfigurable Targets

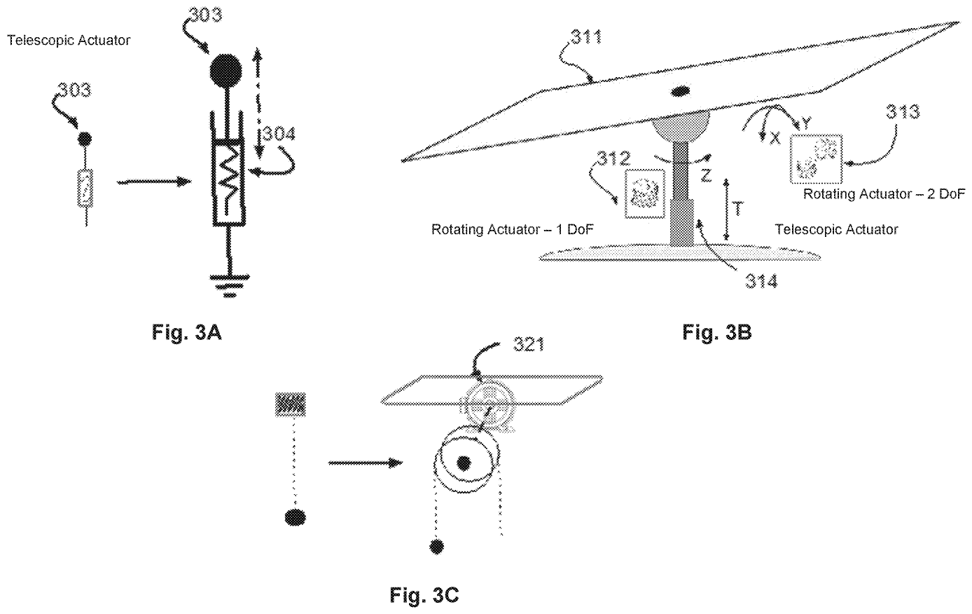

In the first embodiment (labelled 201 in FIG. 2A), the calibration target is constructed using telescopic actuators or motorized rods capable of repositioning markers within a defined volume. Through computer-controlled extension or retraction (as depicted by the actuator mechanism 303 in FIG. 3A), the system dynamically reconfigures the spatial layout of the markers to form various three-dimensional patterns. This adaptability means that a single rig can be optimized for different cameras—whether used in monocular, stereo, or multicamera arrays—without the need for multiple static targets. Such a reconfigurable system is especially beneficial in industrial settings, where it can be integrated into production lines to rapidly calibrate new camera or lens models while minimizing manual intervention and downtime. The precise mechanical control of the actuators further enhances calibration reliability by ensuring consistent and repeatable marker positions.

### 2.2 Hanging Marker Setups

A second embodiment (shown in FIG. 2B) employs a hanging marker setup. Here, various markers 202 are suspended from a support 203 using thin, transparent threads, ensuring that they do not intrude into the camera's primary field of view. This unobtrusive placement makes the markers easier to detect and reduces the risk of occlusion. In some implementations, each marker is also equipped with an electromechanical rolling mechanism (321 in FIG. 3C) that enables vertical adjustments. This additional degree of freedom allows the system to reconfigure the marker layout dynamically, optimizing marker distribution across different heights and improving the three-dimensional cues necessary for accurate calibration. In this embodiment the camera system is placed bellow the marker setup.

### 2.3 Multi-Board Arrangements

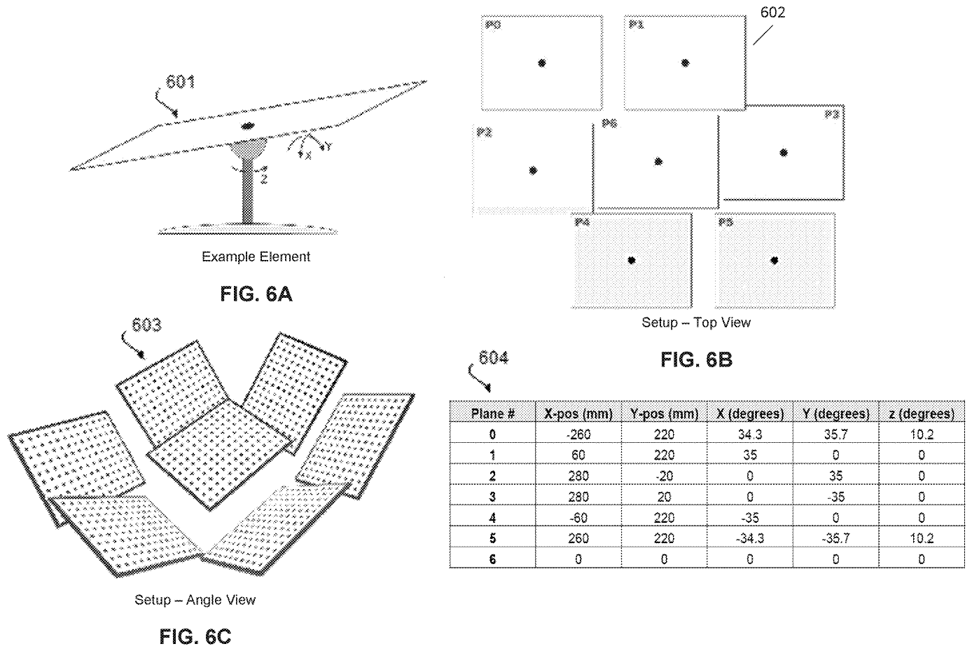

Another prominent embodiment (shown in FIG. 2C) features a multi-board calibration target composed of multiple planar surfaces 204 arranged at varying strategic angles, chosen so to offer unobstructed view and cover the maximum possible area within the field of view of the camera(s). Each board carries high-contrast fiducial patterns—such as dot grids or checkerboards, or the like—that facilitate precise feature detection. The boards are mounted on stands featuring mechanical motion with three degrees of freedom (3 DoF), as shown by the mechanisms 312 and 313 in FIG. 3B, allowing for fine adjustments in orientation to match the requirements of various lenses. A detailed example of this setup is provided in FIGS. 6A-C, where a configuration of seven stands (601 in FIG. 6) is arranged in the X, Y, and Z directions. These stands are positioned in such a way as to avoid occlusions (602 in FIG. 6B and 603 in FIG. 6C), and the specific angular settings of each stand—detailed in Table 604 of FIG. 6B—ensure that even the extreme edges of a wide-angle or fisheye lens are well covered. This multi-board arrangement not only offers comprehensive spatial coverage but also provides strong parallax and three-dimensional structural cues, thereby significantly enhancing the accuracy of both intrinsic and extrinsic parameter estimation.

As FIG. 3 illustrates, each of the aforementioned target embodiments-telescopic/actuator-based rigs, hanging marker setups, and multi-board arrangements-incorporates mechanical components (304, 312, 313, 321) designed to reposition or reorient calibration markers for maximal field of view coverage.

In FIG. 3A, the telescopic actuator mechanism 304 shows how markers can be linearly extended or retracted in real time, enabling dynamic 3D patterns to suit diverse camera and lens configurations.

FIG. 3B focuses on a multi-board setup, where actuators (312, 313) offer three degrees of freedom (3 DoF) for each board surface 311, providing fine-tunable angles to better align with wide-angle or fisheye optics.

Finally, FIG. 3C presents the electromechanical rolling approach using a rolling motor mechanism 321 used in hanging marker systems, allowing markers 212 suspended by transparent threads to be raised or lowered at will, thereby optimizing marker distribution for different imaging scenarios.

By illustrating these actuation mechanisms in one figure, FIG. 3 highlights the key reconfigurability features that unify all three target styles-telescopic rods, multi-board stands, and hanging markers- and underscores how each can be computer-controlled to achieve single-shot calibration coverage for a wide spectrum of camera systems.

### 2.4 Volumetric Display Setup

The final embodiment (labeled 231 in FIG. 2D) utilizes advanced volumetric display technology to create a volumetric plasma display system. Instead of relying on physical markers, this approach projects luminous markers 231 into space using, e.g., one or more infrared pulse laser sources (232 in FIG. 2D) and other optical means facilitating the formation of a 3D point cloud in the air by ionization of air molecules [1], [2]. The resulting floating markers are perceived by the camera as discrete fiducial points located at various depths. One of the major advantages of this method is that, without any physical support structures, the risk of occlusion is virtually eliminated.

Moreover, the projected pattern can be altered dynamically through software, allowing for rapid reconfiguration to suit different calibration scenarios. Additional details highlight that multiple colored lasers may be used to illuminate markers at various heights, further improving detection robustness under diverse lighting conditions. This hands-off approach streamlines the calibration process in industrial settings by removing bulky fixtures and enabling quick adaptation to changing requirements.

It becomes clear that these target configurations are not only complementary but also collectively address many of the limitations inherent in traditional calibration methods. Whether through the mechanical precision of actuator-based systems, the unobtrusive clarity of hanging marker setups, the comprehensive spatial coverage of multi-board arrangements, or the dynamic flexibility of holographic projections, each embodiment is engineered to yield high-fidelity calibration from a single capture. This consolidated approach minimizes calibration time and complexity while ensuring robust three-dimensional cues and high accuracy-qualities that are essential for applications involving wide-angle or fisheye lenses, especially in high-throughput industrial environments.

### 3. Processing Pipeline

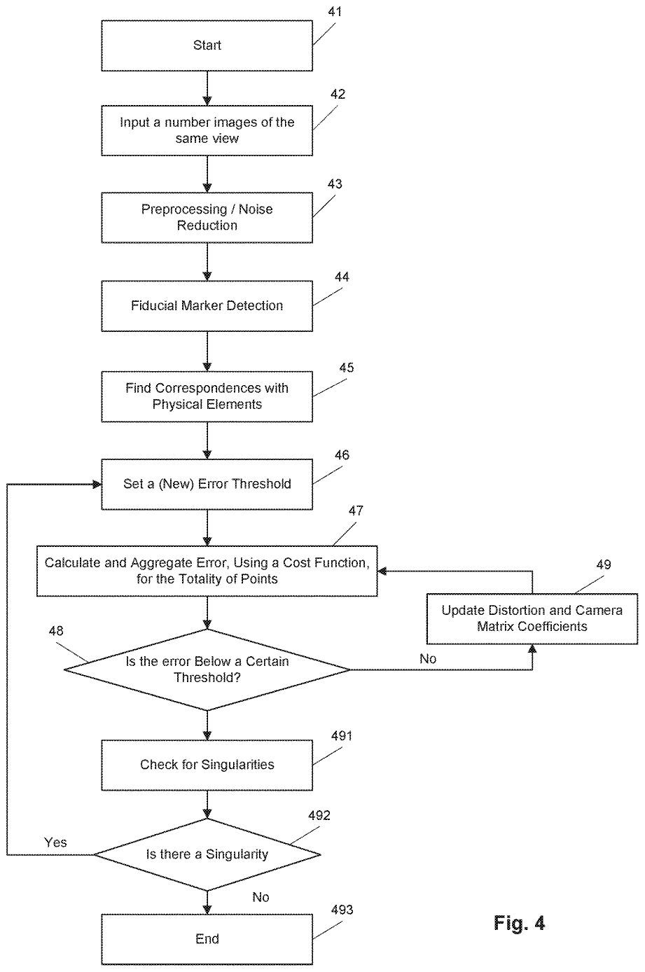

One exemplary embodiment is embodied in its single-view calibration pipeline, which enables the extraction of complete camera parameters from a single view. This calibration pipeline, outlined in FIG. 4, proceeds through several stages, each of which is executed in a sequential and integrated manner.

The process begins with the synchronous capture of images (42 in FIG. 4). In the context of a stereo rig, both the left and right cameras capture images simultaneously. For single-camera calibration, only one image is required. The calibration target, which is placed within the field of view, must be imaged such that its entire known geometry is visible.

Once the images have been captured, the system transitions into the preprocessing stage (43 in FIG. 4). During preprocessing, the raw images are converted into a format amenable to feature extraction; for example, the images may be converted to grayscale to facilitate the detection of high-contrast fiducial markers. Additionally, noise reduction techniques and brightness/contrast normalization may be applied to ensure that the fiducial markers are clearly distinguished from the background. In an exemplary embodiment, multiple shots of a single view are taken so to achieve denoising trough averaging of image frames.

### 3.1 Marker Detection

After preprocessing the raw calibration image to enhance contrast and reduce noise, the system proceeds to the marker or feature detection stage (44 in FIG. 4). The objective is to identify, with sub-pixel precision, the two-dimensional coordinates (uᵢ, vᵢ) of each fiducial in the image. Depending on the design of the calibration target, various image processing or computer vision methods can be employed. In simpler implementations, global or adaptive thresholding can be used if the fiducials have a strong intensity contrast against the background (for instance, black dots on a white board). Each connected blob of pixels above a threshold is located, and its centroid is computed as the average position of all pixels within the blob. Alternatively, contour analysis or binary region labelling may be used to precisely isolate closed shapes in the thresholded image before calculating their geometric centers. For targets that use more sophisticated markers—such as QR codes, ArUco tags, or custom binary patterns—specialized detection techniques parse each marker's internal code, simultaneously identifying the marker's corners and unique ID. More advanced systems can leverage deep learning (e.g., convolutional neural networks) to robustly detect and classify markers under challenging lighting or perspective distortions, allowing a high degree of resilience to real-world conditions.

### 3.2 Marker 2D-3D Association

The next challenge is the mapping detected 2D markers in the image to their physical 3D coordinates or in other words to establish a one-to-one correspondence between what the camera sees and what is known about the placement of markers in the real world (45 in FIG. 4). The approach varies depending on whether one use a multi-board (multi-plane) setup, a volumetric marker arrangement, or a volumetric projection display. Each scenario has its own strategies for labelling markers, ensuring they can be correctly identified and matched in three dimensions.

### 3.2.1 Multi-Board (Multi-Plane) Setup

When the calibration target consists of several planar boards at different angles, each board typically carries a patterned grid of markers, such as circles (dot patterns), checkerboard corners, ArUco tags or other targets. The key is that the exact 3D position of every marker on every board is known beforehand. This knowledge may come from a CAD design or a tabulated list of board poses and marker offsets.

### Board Identification

Each physical board can be distinguished by its position and orientation. In many designs, the boards are arranged with minimal overlap so that, once the software identifies a specific arrangement of markers, it knows which set of 3D coordinates correspond to which board. Alternatively, each board may bear a unique grid dimension or a small textual ID marker.

### Within-Board Marker Mapping

For a given board, the 2D detections often appear as a regular grid (e.g., 5×5 or 10×13 dots). The software finds the top-left corner or identifies a pattern anchor (like a corner dot or a coded marker) to define a row-by-column ordering. Once it knows which row and column each dot belongs to, it can link them to (X, Y) positions in that board's local coordinate plane. Because the board's 3D pose (rotation and translation) in space is pre-defined, these local (X, Y) coordinates become fully known (X, Y, Z) coordinates in the target's global coordinate system.

### Correspondence by Geometry

If the boards are carefully spaced and angled, no two boards produce exactly the same pattern shape from the camera's vantage. Thus, the software uses the arrangement of detected dots to figure out which board each set of dots must belong to, and from there, each 2D dot is mapped to a unique 3D location.

### 3.2.2 Volumetric Arrangement of Markers

In a volumetric setup, markers occupy known 3D positions distributed throughout a region of space, usually mounted on rods, frames, telescopic actuators or hanged by thin threads. Unlike multi-board designs, these markers may not be confined to discrete planes. They can lie at various depths and angles, forming a richer three-dimensional structure.

### Unique Marker IDs

A robust way to identify each marker is to embed a small code, text label, unique color, or unique pattern on it. For example, each marker can carry a numeric or alphanumeric ID that computer vision techniques decode in the captured image. This ensures the software knows precisely which physical marker (with known (X, Y, Z)) it is seeing on the camera's 2D plane.

### Geometric Constraints

If the markers are all identical (e.g., simple dots without IDs), the system can still infer correspondences by comparing distances and angles among detected features. In a volumetric rig that has well-measured inter-marker distances, the software might reason: “Marker A is 50 mm from Marker B and 70 mm from Marker C in 3D. Which set of 2D points in the image replicate those distances?” This approach is more computation-intensive, but it does not require unique IDs on each marker.

### Actuator or Telescopic Rigs

In a reconfigurable volumetric system, each marker's 3D position can vary according to an actuator's extension. However, once the rig's geometry is calibrated (i.e., the system knows exactly how the rods move), the software always has an up-to-date list of (X, Y, Z) for each marker at its current extension. By referencing an internal “marker database,” the technique knows how many markers are visible, plus their newly assigned coordinates, and it solves the same 2D-3D matching problem.

### 3.2.3 Volumetric Display Setup

In a volumetric display approach, the markers do not physically exist in space; rather, they are points of light projected at specific depths and positions. The same fundamental goal applies: every luminous point in 3D is associated with a known (X, Y, Z). The difference is that these coordinates come from optical alignment (the projector's known wavefront or scanning parameters), rather than a physically measured position on a board or rod.

### Pre-Computed 3D Voxels

The projector or holographic system is calibrated in advance so that, when it projects a pattern, each “voxel” or luminous spot appears at a precise location (X, Y, Z) in the calibration volume. This is typically done by running a separate calibration process for the projector itself. The final result is a “lookup table” from “voxel index” to “voxel coordinates.”

### Time or Intensity Coding

Sometimes, ephemeral markers can appear identical if they are all just points of light. To disambiguate them, the system may flicker or modulate each point in a unique time slot or intensity code. That way, the camera sees marker #1 lit at time t1, marker #2 at time t2, and so on. Alternatively, each voxel may have a distinct color or blinking rate, letting the software label each luminous point with a known 3D coordinate.

### Matching in a Single Frame

In many single-shot holographic systems, the entire 3D pattern is displayed at once, so if the pattern is carefully chosen (and the environment is controlled to ensure minimal crosstalk), each projected point can be recognized by its 2D location and (optionally) brightness code. The camera's detection step sees a constellation of points, and the known 3D layout is retrieved from the system's volumetric projector mapping. The matching thus becomes a direct 2D-to-3D assignment for each luminous spot.

As becomes evident, regardless of the target type (multi-board, volumetric rig, or holographic display), the same general principles apply:
Known 3D Layout: Each marker or luminous spot has a definite 3D coordinate in the target's coordinate system.
Detectable 2D Features: The camera detects 2D marker positions (uᵢ, vᵢ).
Identification/Matching: The technique uses unique IDs, geometric constraints, or time/intensity coding to figure out which 2D feature corresponds to which physical (or virtual) 3D position.
Consistent Database: A final “marker dictionary” or “pose table” ensures that each 2D detection (uᵢ, vᵢ) is paired with exactly one (Xᵢ, Yᵢ, Zᵢ)

Once the system establishes these 2D-3D pairings, the system can compute or refine the camera intrinsics (focal length, distortion, etc.) and extrinsics (pose relative to the target, or between multiple cameras), thus completing the calibration loop.

### 3.3 Single-Camera Calibration Pipeline

In this phase, the intrinsic and extrinsic parameters of the camera are estimated by minimizing the reprojection error. The projection model used in this process accounts for the effects of lens distortion, which are especially pronounced in wide-angle and fisheye lenses. The forward projection function is defined as

π(K,D,X,Y,Z)→(u,v) (1)
where K denotes the intrinsic parameter matrix of the camera, and D represents the distortion coefficients, which might e.g. include radial and tangential components. The radial distortion is modelled by a polynomial function such as

r_{distorted}=r(1+k₁r²+k₂r⁴+ . . . ) (2)

while the tangential distortion is described by the equations such as

Δxₜₐₙ=2p₁xy+p₂(r²+2x²),Δyₜₐₙ=p₁(r²+2y²)+2p₂xy] (3)

In these equations, r is the radial distance from the principal point, k₁ and k₂ are the radial distortion coefficients, and p₁ and p₂ are the tangential distortion coefficients.

The overall reprojection error E that the technique seeks to minimize is given by:

E=Σᵢ|(uᵢ,vᵢ)−π(K,D,R,t,Xᵢ,Yᵢ,Zᵢ,kᵢ,pᵢ)|² (4)
where R and t denote the rotation matrix and translation vector, respectively, which together represent the extrinsic parameters of the camera. In the case of stereo calibration, the system determines separate intrinsic parameters (K_{L}, D_{L}), and (K_{R}, D_{R}) for the left and right cameras, respectively, along with the stereo extrinsics (R_{LR}, t_{LR}), that define the relative orientation and position between the two cameras.

To solve for the unknown parameters, the calibration technique employs a nonlinear optimization solver (46-48 in FIG. 4), such as the Levenberg-Marquardt algorithm or a bundle adjustment framework, which iteratively adjusts the parameters to minimize the reprojection error. The process continues until the change in the error function falls below a predetermined threshold Eth, indicating convergence to an optimal solution.

After the optimization stage, the system performs a verification step by reprojecting the known three-dimensional points into the image using the computed parameters. The resulting reprojection errors are analyzed; if the root-mean-square (RMS) error is within acceptable limits defined empirically and in accordance to the application field of the camera system, the calibration is considered successful. Finally, the calibrated parameters—including the intrinsic matrix K, the distortion coefficients D, and the extrinsic parameters (either the absolute camera pose or the stereo extrinsics (R, t) are output and stored. These parameters are then used to undistort new images, perform stereo rectification, or serve as input to further computer vision techniques such as three-dimensional reconstruction.

### 3.3. Undistortion Function Irregularities

In a typical polynomial radial distortion model, the ideal radial distance r (measured from the principal point (cₓ, c_{y}) is mapped to the distorted radial distance r_{distorted} through a polynomial expansion. Let (u, v) be the undistorted image coordinates. First, we compute normalized coordinates:

$${x}^{′} = \frac{u - {c}_{x}}{{f}_{x}} , {y}^{′} = \frac{v - {c}_{y}}{{f}_{y}} \qquad ( 5 )$$

Where (x′, y′) be the normalized coordinates (shifted so that the principal point (cₓ, c_{y}) is at the origin and scaled by the focal length (fₓ, f_{y}). If we define,

r²=x′²+y′²,r²_{distorted}=x_{d}²+y_{d}′² (6)

Then the distorted normalized coordinates (x_{d}, y_{d}) are given by:

x_{d}=x′(1+k₁r²+k₂r⁴+k₃r⁶+ . . . )+2p₁x′y′+p₂(r²+2x′²), (7)

y_{d}=y′(1+k₁r²+k₂r⁴+k₃r⁶+ . . . )+p₁(r²+2y′²)+2p₂x′ (8)
where (k₁, k₂, . . . , p₁, p₂,) are the lens-specific distortion coefficients. Finally, transforming back to pixel coordinates is done by:

u_{d}=fₓx_{d}+cₓ,v_{d}=f_{y}y_{d}+c_{y} (9)
This function must remain strictly continuous over the camera's valid radius. The continuity of the functions can be checked by using indicators such the first and the second derivatives. In this way is possible detect discontinuities in the transfer function.

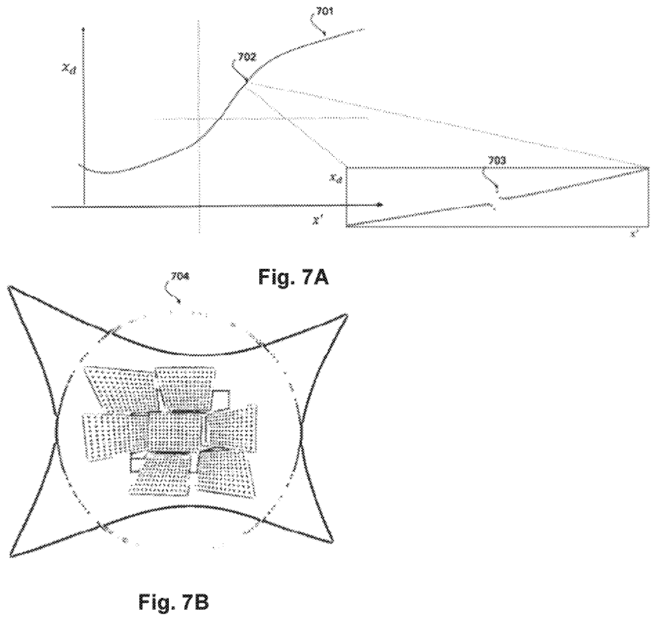

In FIGS. 7A-B, an example of a transfer function is shown (701 in FIG. 7A). At some point though there is a small discontinuity (703 in FIG. 7A) which result into an artifact cycle (704 in FIG. 7B)

In one embodiment, the calibration system includes a post-processing step that analyzes the fitted radial distortion function to ensure it remains strictly continuous (491 in FIG. 4). After an initial run of the optimization—where the technique finds values for the distortion coefficients, the system first oversamples the distortion transfer function in with subpixel accuracy. This is critical, because the discontinuity might not be detectable in pixel accuracy. Then inspects the derivatives of the function to confirm that are within a predefined range. If this derivative analysis detects abnormal behavior that would produce problems, the system flags the result as invalid (492 in FIG. 4). It then restarts or refines the optimization process, increasing the reprojection error threshold. By imposing a higher threshold, the solver is guided away from “bad” parameter configurations and toward a lens model that remains free from irregularities across all relevant radii. This additional step ensures prevents singularities or other effects that might undermine reliable undistortion.

### 4. Stereo Calibration Pipeline

The stereo calibration pipeline builds on the single-camera calibration approach by extending the parameter estimation to encompass two (or more) cameras that observe the same calibration target simultaneously. Rather than capturing multiple images of a planar or volumetric target from different viewpoints, the system collects precisely one stereo pair of images—one from the left camera and one from the right camera—while ensuring both cameras see enough three-dimensional structure in the scene to facilitate a unified calibration process. Each camera has its own intrinsics, including a camera matrix and distortion coefficients, but the pair shares a set of extrinsics that define how the second camera is positioned and oriented relative to the first.

The procedure begins with the simultaneous image acquisition by the left camera and right camera. If the target is designed to offer a sufficiently wide coverage in three-dimensional space, and if both cameras capture the target's fiducial markers from their respective viewpoints, a single stereo pair provides enough data to compute all necessary parameters. In the raw images, the system detects and localizes each fiducial marker, producing a set of two-dimensional coordinates for the left image denoted by

$$( {u}_{i}^{L} , {v}_{i}^{L} )$$

and an analogous set for the right image denoted by

$$( {u}_{i}^{R} , {v}_{i}^{R} ) .$$

The two-dimensional detections are tied to a known three-dimensional position (Xᵢ, Yᵢ, Zᵢ) in the calibration target's coordinate system, allowing the technique to recognize which markers correspond to the same physical point in space.

Once the system has identified correspondences between the left and right images, the system sets up two sets of camera intrinsics (K_{L}, D_{L}) for the left camera and (K_{R}, D_{R}) for the right camera—along with a stereo extrinsic transformation defined by a rotation matrix R_{LR} and a translation vector t_{LR}. Together, these parameters characterize both how each camera projects three-dimensional points onto its image plane and how the two cameras relate to one another in space. To solve for these unknowns, the pipeline employs a nonlinear optimization procedure or a bundle adjustment framework that minimizes a joint reprojection error function. The cost function E can be expressed as:

$$E = {\sum }_{i} {\vert ( {u}_{i}^{L} , {v}_{i}^{L} ) - π ( {K}_{L} , {D}_{L} , {X}_{i} , {Y}_{i} , {Z}_{i} ) \vert}^{2} + {\vert ( {u}_{i}^{R} , {v}_{i}^{R} ) - π ( {K}_{R} , {D}_{R} , {R}_{L R} , {t}_{L R} , {X}_{i} , {Y}_{i} , {Z}_{i} ) \vert}^{2} \qquad ( 10 )$$

where π(⋅) denotes the forward projection function that maps a three-dimensional point (Xᵢ, Yᵢ, Zᵢ) to image coordinates based on the given intrinsics (K, D) and, in the right camera's case, the additional rotation R_{LR} and translation t_{LR}. By summing these squared residuals across all markers, the technique forces the solution to reconcile both sets of projections in a single optimization. As the parameters refine, the cost function decreases, and the solver converges to an optimal set of intrinsics and extrinsics that minimize the reprojection error across the entire stereo image pair.

At the completion of this optimization, each camera's internal parameters are accurately determined, capturing focal length, principal point, and radial or tangential distortion coefficients. Meanwhile, the relative pose of the second camera with respect to the first is encapsulated in the final estimates of R_{LR} and t_{LR}. Once these parameters are validated, the system can rectify the stereo images, ensuring epipolar lines align horizontally in both views; this greatly simplifies subsequent computer vision tasks such as stereo matching or depth estimation. In practical settings, the stereo calibration pipeline benefits from the same single-shot paradigm as the single-camera approach, since both cameras collect their observations in one instant. By avoiding multiple captures from different angles, the process saves time and avoids the risk of misalignment or target movement that can occur between frames in a traditional multi-image workflow.

This single-shot stereo pipeline proves especially advantageous for wide-angle or fisheye lenses because the multi-plane or volumetric target provides strong parallax and covers the extreme edges of each lens's field of view in one go. Even in industrial environments, where conveyor belts and automated processes necessitate quick calibration, both cameras' intrinsics and their mutual extrinsics can be solved in seconds, reducing downtime and ensuring high-quality alignment. In scenarios with more than two cameras, the same principles extend naturally if every camera views the calibration target in a single synchronized capture. Each camera's intrinsics and every pairwise extrinsic transformation can be jointly optimized, producing a coherent multi-camera rig calibration with minimal operator intervention.

### 4.1. Perspective Transformation Matrix or Q-Matrix

When performing stereo calibration, the system estimates not only each camera's intrinsic parameters but also a set of additional data structures that facilitate the post-processing of stereo images for depth calculation or three-dimensional reconstruction. One of the most critical outputs, is the 4×4 reprojection matrix commonly referred to as Q-matrix. The Q matrix enables a direct mapping from disparity (the difference in pixel coordinates between left and right images) to physical three-dimensional coordinates (X, Y, Z).

In the context of stereo geometry, each pixel in the left camera's image plane can be matched to a corresponding pixel in the right camera's image plane. The horizontal shift between the two matches is called the disparity, denoted by d. Once a disparity map is computed, the user often wishes to convert these pixel coordinates into metric 3D coordinates relative to the camera system. The matrix Q encodes the intrinsic and extrinsic stereo parameters (focal lengths, principal points, and baseline) in such a way that a single matrix multiplication transforms a point (u, v, d, 1)^{T} in the disparity space into a point (X, Y, Z, 1)^{T} in real-world space.

A typical form of the Q-matrix, can be written as:

$$Q = ( \begin{matrix}1 & 0 & 0 & - {c}_{x} \\ 0 & 1 & 0 & - {c}_{y} \\ 0 & 0 & 0 & f \\ 0 & 0 & - \frac{1}{B} & \frac{{c}_{x}^{′} - {c}_{x}}{B}\end{matrix} ) \qquad ( 11 )$$

where f is the focal length in pixel units (i.e., the entries from the camera's intrinsic matrix), (cₓ, c_{y}) is the principal point of the (rectified) left camera, (c′ₓ, c′_{y}) might be the effective principal point in the right camera if the calibration indicates a horizontal shift, and B is the baseline, the physical distance between the two camera centers. The exact form of Q can vary slightly depending on the conventions used during rectification, but the essential concept remains that Q provides a compact way of mapping from (u, v, d) to (X, Y, Z).

Once Q is obtained, the user can convert any pixel coordinate (u, v) in the left image and its associated disparity dd into a three-dimensional point by multiplying:

$$( \begin{matrix}X \\ Y \\ Z \\ 1\end{matrix} ) = Q \cdot ( \begin{matrix}u \\ v \\ d \\ 1\end{matrix} ) \qquad ( 12 )$$

The resulting (X, Y, Z) describe the spatial location of the imaged point in a coordinate system consistent with how the cameras were calibrated and rectified. For example, if one chooses the coordinate system such that Z points forward from the camera, X is horizontal, and Y is vertical, then Q ensures that points at zero disparity project to infinitely large Z, points with higher disparity values come out closer, and so forth.

Beyond the Q matrix, the stereo calibration step also typically provides the rectification transforms that align the left and right images. These transforms may be given as two 3×3 rotation matrices, denoted R₁ and R₂, and two 3×3 projection matrices, P₁ and P₂. These matrices are used to warp or rectify each camera's image onto a common plane where epipolar lines are horizontal, thus simplifying disparity computation. Once the images are rectified, the user generates a disparity map via block matching or more sophisticated stereo matching techniques, and then uses Q to transform the disparity map into a three-dimensional point cloud.

During stereo calibration in a single-shot scenario, the solver determines R_{LR} and t_{LR} (the rotation and translation between the cameras), as well as each camera's intrinsics (K_{L}, D_{L}) and (K_{R}, D_{R}). It then applies a rectification procedure—if desired—to produce a consistent geometry for scanning across horizontal lines. Internally, these parameters become the basis for constructing the Q matrix. Hence, the Q matrix is inseparably tied to the combined intrinsic and extrinsic parameters estimated from the single stereo image pair.

### 5. Example Results

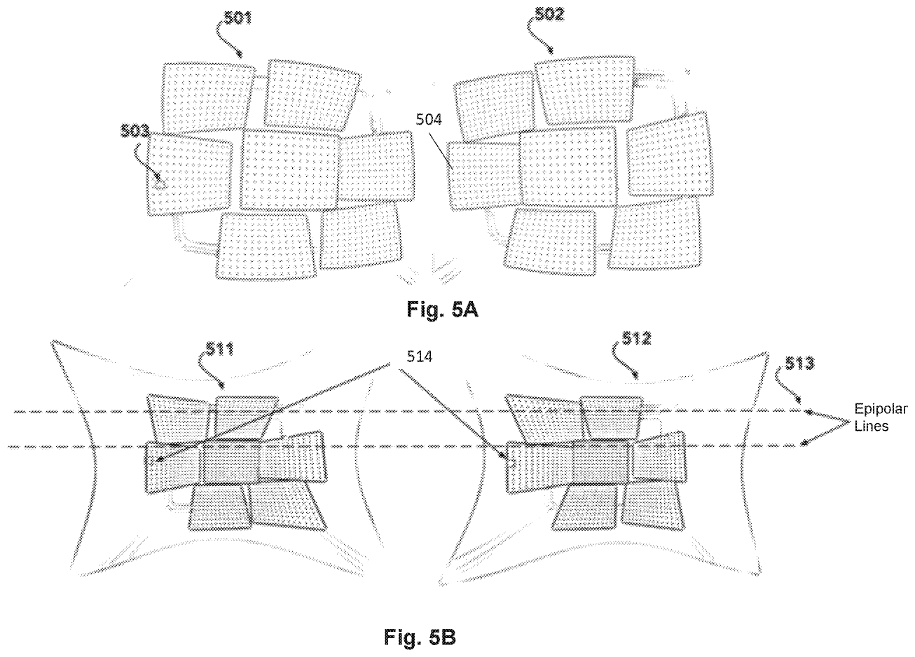

FIGS. 5A-B provide a comprehensive demonstration of the single-shot calibration method in action. The figure is divided into several parts that illustrate the complete calibration workflow and its outcomes:
Original Stereo Images: Sub-FIGS. 501 and 502 display the raw stereo images captured using wide-angle lenses. These images were obtained from a multiboard target setup, which is critical for ensuring that the calibration technique receives robust three-dimensional structural cues across the entire field of view.
Fiducial Detection: 503 in FIG. 5A depicts, a fiducial marker on the original image of the left camera (501) and 504 on the right camera (502). The precise detection of these high-contrast markers validates the feature extraction phase of the calibration pipeline and confirms that the calibration target is effectively visible across the image, even towards the periphery of the lens's wide field.
Undistorted and Rectified Images: In FIG. 5B, 511 and 512—further illustrate the transformation achieved after the calibration process. After applying the optimized intrinsic and extrinsic parameters, the images are undistorted and rectified such that the epipolar lines (513 in FIG. 5B) align horizontally. This alignment is a key indicator that the stereo calibration has been successful, ensuring accurate depth estimation and three-dimensional reconstruction. 514 in FIG. 5B also depicts the detection of a pair of points for calculating the disparity between the two stereo input images.

### 6. Additional Embodiments and Variations

In various embodiments, the technique is not limited to a single configuration or target design but rather encompasses a broad range of applications and implementations. The following subsections describe alternative embodiments and variations that illustrate the versatility and adaptability of the single-shot calibration approach.

### 6.1 Single Camera Only

In certain applications, such as augmented reality (AR) tracking, it is sufficient to determine only the intrinsic parameters and the absolute pose of a single camera relative to a known three-dimensional target. In these embodiments, the same single-shot approach described above is employed to solve for the camera's parameters using one image. Although the calibration target may be simplified compared to the multi-plane or multi-board designs used for stereo calibration, it still requires some out-of-plane structure. This is essential to recover the full six degrees of freedom (6 DOF) of the camera's pose, that is, its three translational and three rotational components. The three-dimensional features of the target allow the calibration technique to compute the transformation matrix, typically expressed as a rotation matrix R and a translation vector tt, that relates the camera coordinate system to the target coordinate system. Thus, even in a single-camera scenario, the method ensures that the camera's intrinsic matrix K and distortion coefficients D, are accurately determined, while also providing an absolute pose estimate for applications requiring precise spatial localization.

### 6.2 Multi Camera Arrays

The exemplary techniques are readily extendable beyond dual-camera stereo systems to calibrate multi-camera arrays. In these embodiments, a system comprising N cameras is employed, where N≥2. With a single synchronous capture of a calibration target that is rich in three-dimensional features, the calibration technique is capable of estimating each camera's intrinsic parameters as well as the extrinsic parameters that define the relative orientations and positions of all cameras in the array. In a multi-camera system, separate intrinsic parameters, (K₁, D₁), (K₂, D₂), . . . , (K_{N}, D_{N}), are determined for each camera, and the extrinsic parameters are represented as a set of transformation matrices or relative rotation and translation pairs, such as (Rᵢⱼ, tᵢⱼ) for each camera pair i and j. The unified optimization process minimizes the reprojection error across all cameras simultaneously, ensuring that the system is coherent and that the calibration is both robust and highly accurate. This embodiment is particularly useful for complex imaging systems, such as those used in virtual reality (VR), panoramic capture, and advanced robotics, where precise multi-camera alignment is critical.

### 6.3 Marker Types

One exemplary advantage is the system's flexibility regarding the type of markers used on the calibration target. The technique is agnostic to the specific pattern or marker type, provided that the three-dimensional location of each marker is either known or can be reliably derived. In various embodiments, the calibration target may incorporate dot patterns, checkerboards, ArUco markers, QR codes, or any other robustly detectable features. For example, a dot pattern may consist of a grid with precisely defined spacing, such that each dot's center is positioned at a known coordinate within the target's reference frame. Similarly, a checkerboard pattern or a set of ArUco markers can be used, where each marker carries an identifier that enables the calibration technique to assign it a unique three-dimensional coordinate. The versatility in marker selection allows the calibration method to be adapted to different environmental conditions, optical properties, and manufacturing constraints, ensuring that the method can be applied in a wide range of scenarios without being restricted to a single type of calibration target.

### 6.3.1 Holographic Tags—CiraTags

One particularly innovative addition to this set of markers is CiraTags, a new fiducial marker type designed to improve robustness, detection efficiency, and real-world usability. CiraTags introduce at least three key advancements over traditional markers:

### Circular Geometric Structure

Unlike square markers such as ArUco, CiraTags feature a circular boundary, making them rotation-invariant and ensuring consistent detection regardless of orientation.

### Radial Barcode Encoding

CiraTags encode unique marker IDs using binary radial segments, similar to a QR code but structured in a circular fashion. This improves readability from various angles and enables partial occlusion resistance.

### Holographic Reflective Center

The central region of each CiraTag is intentionally left empty for holographic or reflective material. This allows polarization-based detection, making it more resistant to challenging lighting conditions such as glare, shadows, or extreme brightness changes.

### Advantages of CiraTags Over Traditional Markers

Improved Detection Robustness: Traditional ArUco and QR markers suffer from errors in harsh lighting conditions, while CiraTags leverage their reflective properties for better recognition.
Better Occlusion Handling: The radial barcode system allows partial marker visibility while still retaining enough data for accurate detection.
Scalability & Versatility: CiraTags support a wide range of unique IDs and can be optimized for different applications such as robotics, AR, and industrial automation.

CiraTags are based on a circular fiducial marker system, designed to address the aforementioned limitations comprising:
1. An outer circular boundary detectable via circle or contour-finding algorithms, ensuring rotation invariance.
2. A central disc that can be holographic or reflective, improving recognition under extreme lighting, glare, or polarization conditions.
3. One or more radial wedge segments extending between the central disc and the outer boundary, encoding marker-specific identifiers via angular position, angular width, and/or binary patterns.

These features collectively enable robust detection, occlusion tolerance, and scalability in various real-world applications such as robotics, AR systems, industrial automation, and camera calibration procedures.

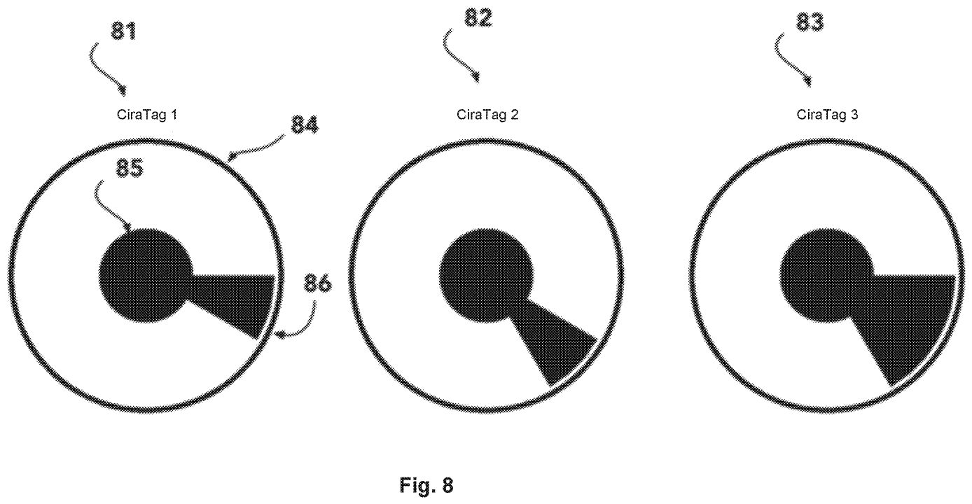

In one illustrative embodiment, illustrated in FIG. 8, each CiraTag is formed by a circular outer boundary, a central disk, and a radial wedge that extends between the disk and the boundary. This design provides a robust fiducial marker that can be readily detected by computer-vision techniques, even under challenging viewing angles or lighting conditions. As shown in FIG. 8, three example CiraTag (CiraTag 1 (81 in FIG. 8), CiraTag 2 (82 in FIG. 8), and CiraTag 3 (83 in FIG. 8)) demonstrate how the angular position and area of the radial wedge can be varied in order to create unique identifiers.

More specifically, each CiraTag incorporates a prominent circular ring (845 in FIG. 8), at its outer periphery. The circular geometry is advantageous because it imparts a degree of rotation invariance to the marker: standard circle or contour-detection techniques, such as Hough transforms, can reliably locate the boundary, thereby simplifying subsequent steps of marker recognition. Within this circular ring lies a central disk (85 in FIG. 8), which may be fabricated from or coated with holographic or reflective material. In certain embodiments, the reflective qualities of this central disk are exploited to enable polarization-based detection, thereby enhancing marker visibility in environments prone to glare, fluctuating brightness, or other adverse optical conditions.

The radial wedge (86 in FIG. 8) represents a further critical aspect of the CiraTag design. Extending radially outward from the central disk to the circular boundary, this wedge can vary in angular width, direction, and shape. By measuring such attributes in the captured image, the detecting system can resolve a range of unique identifiers or data bits. For example, in FIG. 8, CiraTag 1 (81 in FIG. 8) is shown having a wedge oriented approximately to the left side of the center disk, while CiraTag 3 (83 in FIG. 8) exhibits a wedge occupying a larger angular segment on the right side. The difference in wedge positions and extents can be used to differentiate between multiple markers, even when the markers appear similar at a glance.

Moreover, the interplay between the outer circular boundary, the central disk, and the radial wedge enables robust detection under partial occlusion. If a portion of the wedge is obstructed from view—such as by an intervening object in the scene—the intact geometry of the circular boundary and the partially visible wedge segment can often still suffice for accurate identification. In some embodiments, multiple wedges or concentric wedge rings may be incorporated, allowing the marker to store additional bits of information or to employ error-correction schemes akin to those used in radial barcodes.

Once the detecting system locates the CiraTag in an image, it may apply standard computer-vision techniques to estimate the pose of the marker relative to the camera. By fitting an ellipse to the apparent shape of the circular boundary and the central disk under perspective projection, one can extract three-dimensional orientation information, which is vital for applications such as robotic navigation, augmented reality overlays, or single-shot calibration processes. Furthermore, when a holographic or reflective material is used for the center disk, the system may incorporate polarization filters to measure the intensity and phase of the reflected light, thus improving detection reliability under uneven illumination.

In certain implementations, the circular design of CiraTags may be augmented with colored segments or holographic micro-patterns. Such variations provide additional sources of discrimination when multiple markers appear within the camera's field of view. They also create resilience to noise or distortion, since the marker's ID can be confirmed via multiple attributes—angular wedge position, color, or pattern reflectivity—instead of relying on a single visual feature.

This three-component structure—circular boundary, central disk, and radial wedge—ensures that each CiraTag is rotation-invariant, robust to partial occlusion, and capable of functioning under varying lighting conditions. Consequently, CiraTags may be advantageously incorporated into a wide variety of single-shot calibration systems. In such cases, their unique radial encoding facilitates unambiguous correspondence between two-dimensional image detections and known three-dimensional marker coordinates, thereby streamlining the intrinsic and extrinsic parameter estimation for cameras, stereo rigs, or larger multicamera setups.

### 6.4 Industrial Integration

In industrial environments, rapid and reliable calibration of cameras is a necessity, particularly in automated manufacturing lines and quality control systems. The single-shot calibration approach described herein is exceptionally well-suited for such applications, as it allows for the calibration of each camera or camera array in a matter of seconds. In a typical conveyor belt manufacturing setup, each new camera installed on the production line can be quickly calibrated by capturing a single image or stereo pair of a standardized calibration target. This minimizes downtime and maximizes throughput, as the calibration process does not require the repositioning of the camera or target multiple times. Moreover, the high degree of accuracy achieved by the single-shot method, as evidenced by low root-mean-square (RMS) reprojection errors, ensures that the calibrated parameters are reliable for subsequent tasks, such as real-time image rectification, three-dimensional reconstruction, or automated defect detection. The integration of this calibration method into industrial systems thereby contributes to overall operational efficiency, reduced maintenance costs, and enhanced product quality.

The exemplary systems and methods described herein primarily relate to camera calibration and imaging systems. However, to avoid unnecessarily obscuring the present disclosure, certain well-known structures and devices are omitted from the preceding description. Such omissions should not be interpreted as limitations on the scope of the claims. Specific details provided herein facilitate understanding of the disclosure, yet it should be appreciated that this disclosure may be practiced beyond the explicit details presented.

Furthermore, although the components described herein may be depicted as collocated, certain elements of the system may be remotely located within various portions of distributed networks such as LANs, the Internet, or dedicated systems. Components may be combined into single or multiple devices including personal computers (PCs), laptops, netbooks, smartphones, tablets, or other similar devices. Communication links between components may be wired, wireless, or combinations thereof, utilizing electrical signals carried by media such as coaxial cables, copper wires, fiber optics, or even acoustic or light waves.

The flowcharts and methodologies described and illustrated herein should be understood to allow for modifications, additions, or omissions in sequence without materially affecting the functionality of the disclosed embodiments.

It should be noted that the systems and methods described may be implemented using general-purpose or special-purpose computers, microprocessors, microcontrollers, ASICs, DSPs, programmable logic devices, or other hardware or software solutions known in the art. Software implementations may include distributed processing, parallel processing, or virtual machine processing, adaptable to a variety of computer platforms and environments.

While certain processors and standards have been referenced, the disclosure is not limited to these specific examples, as similar or superior processors, standards, and protocols may emerge and are considered within the scope of this disclosure.

Moreover, this disclosure encompasses all aspects, configurations, embodiments, sub-combinations, and subsets thereof, whether or not explicitly depicted and described. The presented discussion is intended solely for illustration and clarity, and should not limit the disclosure to the precise forms disclosed herein. Each claim is intended to represent an independent embodiment of the invention, not necessarily requiring all the features described herein.

Lastly, the detailed descriptions, including the referenced embodiments and variations, illustrate the versatility and scope of the invention, extending beyond the explicitly described forms to encompass alternative, interchangeable, or equivalent structures, functions, or methods as recognized by those skilled in the art

### REFERENCES (ALL OF WHICH ARE INCORPORATED HEREIN BY REFERENCE IN THEIR ENTIRETY)

[1] Ochiai, Y. et al. “Fairy Lights in Femtoseconds: Aerial Volumetric Displays Using Laser-Induced Plasma,” ACM Transactions on Graphics, 2016.
[2] Smalley, D. et al. “A photophoretic-Trap volumetric display,” Nature, 2018.

1-17. (canceled)

18. A fiducial marker configured for computer vision applications, the fiducial marker comprising:
a circular outer boundary sized and shaped to be detectable by circle or contour based computer vision techniques;
a central region configured as a reflective or holographic disk, the central region being centered within the circular outer boundary;
a radial wedge portion extending between the central region and the circular outer boundary, wherein the radial wedge portion includes a data encoding scheme based on at least one of:
(i) a binary pattern formed by angular segments around the central region,
(ii) variable angular width of the wedge, or
(iii) multiple concentric wedges providing error correcting codes;
whereby the combination of the circular outer boundary, the central region, and the radial wedge portion imparts rotational invariance, partial occlusion resistance, and robust detection under varying lighting conditions.

19. The fiducial marker of claim 18, wherein the central region is coated with or composed of a holographic material, and the fiducial marker is configured to be detectable by polarization based imaging, thereby increasing visibility in environments subject to glare or fluctuating illumination.

20. The fiducial marker of claim 18, further comprising at least one additional radial wedge segment concentric with the first radial wedge portion, the additional radial wedge segment storing supplementary data bits, wherein the fiducial marker supports an extended range of unique identifiers for use in robotic navigation, augmented reality, or single shot camera calibration procedures.

21-26. (canceled)
